(19) United States
(12) Patent Application Publication
(10) Pub. No.: US 2007/0090328 A1
(43) Pub. Date: Apr. 26, 2007

(54) Rare-earth iodide scintillation crystals

(75) Inventors: Pieter Dorenbos, Rijswijk (NL); Carel Wilhelm Eduard Van Eijk, Delft (NL); Hans-Ulrich Gudel, Thorisaus (CH); Edgar Valentijn Dieuwer Van Loef, Rotterdam (NL); Karl Wilhelm Kramer, Berne (CH)

Correspondence Address: OBLON, SPIVAK, MCCLELLAND, MAIER & NEUSTADT, P.C., 1940 DUKE STREET, ALEXANDRIA, VA, 22314, US

(73) Assignees: STICHTING VOOR DE TECHNISCHE WETENSCHAPPEN, Utrecht (NL); UNIVERSITE DE BERNE, Berne (CH)

(21) Appl. No.: 10/559,338

(22) PCT Filed: Jun. 1, 2004
(86) PCT No.: PCT/EP04/05899

§ 371 Date: Nov. 17, 2006

(30) Foreign Application Priority Data
Jun. 5, 2003 (FR) 03/06822

(51) Int. Cl. C09K 11/08; C09K 11/61

(52) U.S. Cl. 252/301.4 H; 117/940

(57) ABSTRACT

The invention relates to an inorganic rare-earth iodide scintillation material of formula A_{X}Ln_{(y-y′,)}Ln′_{y′}I_{(x+3y)} in which: A represents at least one element selected among Li, Na, K, Rb, Cs; Ln represents at least one first rare-earth element selected among La, Gd, Y, Lu, said first rare-earth element having a valency of 3+ in the aforementioned formula: Ln′ represents at least one second rare-earth element selected among Ce, Tb, Pr, said second rare-earth element having a valency of 3+ in the aforementioned formula, x is an integer and represents 0, 1, 2 or 3; y is an integer or non-integer greater than 0 and less than 3, and; y′ is an integer or non-integer greater than 0 and less than y. This material presents a high stopping power, a rapid decay time, in particular, less than 100 ns, a good energy resolution (in particular, less than 6% at 662 keV) and a high luminous level. This material can be used in nuclear medicine equipment, in particular, in Anger-type gamma cameras and in positron emission tomography scanners.

The invention relates to inorganic scintillator crystals of the rare-earth iodide type, a production process allowing them to be obtained and the use of said crystals, especially in gamma-ray and/or X-ray detectors.

Scintillator crystals are widely used in detectors for gamma-rays, X-rays, cosmic rays and particles whose energy spans the range in particular of 1 keV to 10 MeV.

A scintillator crystal is a crystal that is transparent in the scintillation wavelength range and which responds to incident radiation by the emission of a light pulse. The light pulse depends on the crystal and is as intense as possible. This pulse is expressed as a ratio to the incident energy absorbed by the material in photons per MeV absorbed. Crystals are sought whose light emission is as intense as possible.

Detectors can be made from such crystals, generally single crystals, where the light emitted by the crystal that the detector comprises is coupled to a means of detection of the light (or photodetector, such as a photomultiplier) which produces an electrical signal proportional to the number of light pulses received and their intensity. Such detectors are especially used in industry for thickness or weight dosage measurements, in the fields of nuclear medicine, physics, chemistry and oil prospecting.

Another desired parameter for the scintillator material is its stopping power for X- or gamma-rays which, to a first order, depends on ρ.Z⁴ (ρbeing the density, Z the effective atomic number of the compound). A second criterion is its luminous efficiency per incident photon absorbed, expressed in the text below in Photons/MeV at 662 keV, the energy of the principal gamma emission of ¹³⁷CS.

One of the other parameters that it is desired to improve is the energy resolution.

Indeed, in the majority of the applications for nuclear detectors (detection of X-, α-, β-, gamma-rays, electrons, neutrons and other charged particles), a good energy resolution is desirable. The energy resolution of a nuclear radiation detector effectively determines its capacity to separate closely-spaced radiation lines. It is usually determined, for a given detector at a given incident energy, as the ratio of the width at half-height of the peak concerned to the energy at the centroid of the peak in an energy spectrum obtained with this detector (see for example : G. F, Knoll, “Radiation Detection and Measurement”, John Wiley and Sons, Inc, 2nd edition, p 114). In the following text, and for all the measurements carried out, the resolution is determined at 662 keV, the energy of the principal gamma emission of ¹³⁷Cs.

The smaller the energy resolution number, the better is the quality of the detector. Energy resolutions of around 7% are considered to be sufficient to allow good results to be obtained, but it is still desired to further improve this parameter. Indeed, as an example, in the case of a detector used for analyzing various radioactive isotopes, a better energy resolution allows the detector to better distinguish between these isotopes. An improvement in the energy resolution (appearing as a lower resolution value) is also particularly advantageous for a medical imaging device, for example of the Anger gamma camera or Positron Emission Tomography (PET) type, since it allows the contrast and the quality of the images to be greatly improved, which thus allows a more accurate and earlier detection of tumours.

Another very important parameter is the scintillation decay time. This parameter is usually measured by the method known as “Start Stop” or “Multi Hit”, (described by W. W. Moses in Nucl. lnstr and Meth. A336 (1993) 253). As short a decay time as possible is desirable, such that the operating frequency of the detectors can be increased. In the field of nuclear medical imaging, this for example allows the duration of examinations to be considerably reduced. In addition, a short decay time allows the time resolution of devices detecting events in time coincidence to be improved. This is the case for PET, where the reduction in the decay time of the scintillator allows the images to be significantly improved by rejecting the non-coincident events with a greater precision.

A family of known and widely used scintillator crystals is of the thallium-doped sodium iodide type, NaI(Tl). This scintillator material, discovered in 1948 by Robert Hofstadter, forms the basis of modern scintillators and still remains the predominant material in this field despite close to 50 years of research into other materials. Its luminous efficiency is in the range 38,000-40,000 photons/MeV. However, these crystals have a slow scintillation decay of around 230 ns. Moreover, their energy resolution (at around 7% when irradiated by ¹³⁷Cs) and also their stopping power (ρ*Z⁴=24×10⁶) are no more than average.

A material also used is CsI, which depending on the application may be used in the pure form or doped with either thallium (Tl) or with sodium (Na). However, CsI(Tl) and CsI(Na) have long decay times, especially greater than 500 ns.

A family of scintillator crystals that has known a significant development is that of the bismuth germanate (BGO) type, owing especially to its high stopping power. However, the crystals of the BGO family have long decay times that limit the use of these crystals to applications with low count rates. In addition, their luminous efficiency (expressed in number of photons per MeV absorbed) remains 4 to 5 times lower than that of NaI:Tl crystals, of about 8,000-9,000 photons/MeV.

A more recent family of scintillator crystals was developed in the 1990's and is of the cerium-activated Lutecium oxyorthosilicate LSO(Ce). However, these crystals are very heterogeneous and have very high melting points (around 2200° C.). Their energy resolution is far from excellent and, more often than not, exceeds 10% under ¹³⁷Cs radiation.

XLn₂Cl₇ and XLn₂Br₇ are also known, these two families being doped with cerium, with X representing an alkali metal, especially Cs or Rb, and Ln a rare earth. Of these compounds, RbGd₂Br₇:Ce is the most attractive but is expensive to produce. Furthermore, Rb exhibits a high background radiation noise level owing to the isotope ⁸⁷Rb, which noise alters the quality of the scintillator output signal. Other work has been carried out with K₂LaCl₅:Ce (see Hans van't Spijker et al., [Rad. Meas. 24(4) (1995) 379-381], [J. Lumin. 85 (1999) 1-10]). Its luminous efficiency is however only half of that of NaI:Tl (20,000 ph/MeV) and the luminous emission of the material contains a slow component. In addition, its stopping power for incident X- or gamma-rays is low (ρ*Z⁴=11×10⁶).

WO 01/60944 and WO 01/60945 teach that compositions respectively of the Ln₁₋ₓCeₓCl₃ and Ln₁₋ₓCeₓBr₃ type, where Ln is chosen from the lanthanides or mixtures of lanthanides and where x is the molar substitution fraction of Ln by cerium, and in particular LaCl₃:Ce and LaBr₃:Ce, exhibit a fast decay time with a fast component of 25-35 ns and an excellent energy resolution reaching 2.9-3.1%. However, their stopping power remains moderate, especially equal to 25.10⁶ for LaBr3:0.5% Ce.

The article published in the Journal of luminescence 85, 1999, 21-35 (Guillot-Noël et al.) teaches that a crystal of LuCl₃ doped with 0.45% of Ce exhibits an emission intensity of 5,700 photons/MeV at 662 keV and an energy resolution of 18%. It also teaches that a crystal of LuBr₃ doped with 0.46% of Ce exhibits an emission intensity of 18,000 photons/MeV at 662 keV and an energy resolution of 8%.

The subject of the invention is an inorganic scintillator material of the iodide type with formula AₓLn_{(y-y′)}Ln′_{y′}I_{(x+3y)}in which
A represents at least one element chosen from Li, Na, K, Rb, Cs,
Ln represents at least a first rare earth chosen from La, Gd, Y, Lu, said first rare earth being of valency 3+ in said formula,
Ln′ represents at least a second rare earth chosen from Ce, Tb, Pr, said second rare earth being of valency 3+ in said formula, (this second rare earth is also named ‘dopant’ in the following description)
x is an integer and represents 0, 1, 2 or 3,
y is an integer or non-integer value and greater than 0 but less than 3,
y′ is an integer or non-integer value greater than 0 and less than y.

The material according to the invention exhibits a high stopping power, a fast decay time, especially less than 100 ns, a good energy resolution (especially less than 6% at 662 keV) and a high luminous intensity.

The material according to the invention may comprise impurities that are usual in the technical field of the invention. The usual impurities are generally impurities originating from the raw materials in which their concentration by mass is especially less than 0.1%, or even below 0.01%, and/or parasitic chemical phases (for example the phase KI in K₂LaI₅) of which the concentration by volume is especially less than 1%.

For Ln′ in the above formula, Ce, then Tb, then Pr is preferred.

Preferably, y′ ranges from 0.001 y to 0.9 y (which means that the molar substitution fraction of Ln by Ln′ ranges from 0.1% to 90%), and ranges more preferably from 0.001 y to 0.1 y , or even from 0.001 y to 0.01 y. In particular, y′ can range from 0.003 y to 0.01 y. In particular, y can be unity. In the case where Ln is La, it is preferred that x be non-zero.

The following materials according to the invention may be mentioned:
K₂La_{(1-y′)}Ce_{y′}I₅
K₂La_{(1-y′)}Tb_{y′}I₅
Lu_{(1-y′)}Ce_{y′}I₃
Lu_{(1-y′)}Tb_{y′}I₃
Cs₃La_{(1-y′)}Ce_{y′}I₆
Cs₃La_{(1-y′)}Tb_{y′}I₆
Cs₃Lu_{(1-y′)}Ce_{y′}I₆
Cs₃Lu_{(1-y′)}Tb_{y′}I₆
Cs₃Lu_{(2-y′)}Ce_{y′}I₉
Cs₃Lu_{(2-y′)}Tb_{y′}I₉
Na₃Gd_{(1-y′)}Ce_{y′}I₆
Na₃Gd_{(1-y′)}Tb_{y′}I₆
K₃Gd_{(1-y′)}Ce_{y′}I₆
K₃Gd_{(1-y′)}Tb_{y′}I₆
Cs₃Gd_{(1-y′)}Ce_{y′}I₆
Cs₃Gd_{(1-y′)}Tb_{y′}I₆
Cs₃Gd_{(2-y′)}Ce_{y′}I₉
Cs₃Gd_{(2-y′)}Tb_{y′}I₉
K₃Lu_{(1-y′)}Ce_{y′}I₆
K₃Lu_{(1-y′)}Tb_{y′}I₆
Cs₃Lu_{(2-y′)}Ce_{y′}I₉
Cs₃Lu_{(2-y′)}Tb_{y′}I₉
K₃Y_{(1-y′)}Ce_{y′}I₆
K₃Y_{(1-y′)}Tb_{y′}I₆
Cs₃Y_{(1-y′)}Ce_{y′}I₆
Cs₃Y_{(1-y′)}Tb_{y′}I₆
Cs₃Y_{(2-y′)}Ce_{y′}I₉
Cs₃Y_{(2-y′)}Tb_{y′}I₉

The materials K₂La_{(1-y′)}Ce_{y′I}₅ and Lu_{(1-y′)}Ce_{y′}I₃ are especially suitable.

The material according to the invention may, furthermore, be optimized with respect to considerations of the electronic energy levels. In particular, if the energy transition responsible for the emission peak is considered, it is observed that the position of these energy levels within the bandgap is very important. This can form the basis of a preference rule for some of the compounds according to the invention.

According to one embodiment, the scintillator material according to the invention is a single crystal allowing highly transparent parts to be obtained whose dimensions are large enough to stop and detect the radiation to be detected efficiently, including high-energy radiation (especially above 100 keV). The volume of these single crystals is especially of the order of 10 mm³, occasionally greater than 1 Cm³ or greater even than 10 cm³.

According to another embodiment, the scintillator material according to the invention is a crystallized powder or a polycrystal, for example in the form of powders mixed with a binder or else in sol-gel form.

The material according to the invention can especially be obtained in single crystalline form by a vertical Bridgman-type growth, for example in vacuum-sealed quartz bulbs. The fusion/crystallization is of the congruent type.

The material according to the invention can especially be used as a component of a radiation detector, especially for gamma- and/or X-rays.

Such a detector especially comprises a photodetector optically coupled to the scintillator in order to produce an electrical signal in response to the emission of a light pulse produced by the scintillator. The photodetector of the detector can especially be a photomultiplier or a photodiode, or alternatively a CCD (Charge Coupled Device) sensor.

The preferred use of this type of detector is in the field of gamma- or X-ray measurement, however such a system is also capable of detecting alpha-rays, beta-rays and electrons. The invention also relates to the use of the above detector in nuclear medical equipment, in particular Anger-type gamma cameras and positron emission tomography scanners (see for example C. W. E. Van Eijk, “Inorganic Scintillator for Medical Imaging ”, International Seminar on New Types of Detectors, 15-19 May 1995 —Archamp, France, published in “Physica Medica”, Vol XII, supplement 1, June 1996).

According to another variant, the invention relates to the use of the above detector in oil drilling detection equipment (see for example “Applications of scintillation counting and analysis”, in “Photomultiplier tube, principle and application”, Chapter 7, Philips).

### EXAMPLES

K₂LaI₅ according to the invention, K₂LaCl₅, K₂LaBr₅ as comparative examples, and LuI₃ according to the invention were synthesized. All the samples were doped with cerium (0.7% for y′ as in the formula AₓLn_{(y-y′)}Ln′_{y}I_{(x+3y)} for the first three compounds and 0.5% for LuI₃).

The following were used as starting constituents for K₂LaI₅, K₂LaCl₅, K₂LaBr₅:
KCl, KBr, KI (Merck, suprapur):
LaCl₃/Br₃ and CeCl₃/Br₃ which were prepared from La₂O₃ by the ammonium halide method;
LaI₃ and CeI₃ which were synthesized from the elements (La, K et I) according to the method described by G. Meyer in “Synthesis of Lanthanides and Actinides compounds”, edited by G. Meyer and L. Morss (Kluwer, Dordrecht, 1991), p 145.

As regards LuI₃ and CeI₃, these were synthesized respectively from the elements Lu and I on the one hand, Ce and I on the other.

In order to remove trace amounts of water and oxygen, the constituents were purified by sublimation in tantalum or silica bulbs. For single crystal growth, stoichiometric quantities of the starting products were sealed in a silica bulb under vacuum. The manipulation of all the ingredients and materials was carried out under inert atmosphere, especially in glove boxes containing less than 0.1 ppm of water.

The samples used for the examples were small single crystals, with a volume of the order of 10 mm³. The measurements were carried out using γ-ray excitation at 662 keV. The emission intensity is expressed in photons per MeV. The scintillation decay times were measured by the method known as “Multi Hit” described by W. W. Moses (Nucl. Instr and Meth. A336 (1993) 253). The crystals were mounted onto Philips XP2020Q Photomultipliers. The fast scintillation component was characterized by its decay time, τ, expressed in nanoseconds, and by its scintillation intensity which represents the contribution of this component to the total number of photons emitted by the scintillator (last column of the Table). The acquisition time window for the signal was 10 μs.

It is observed in the example 3 that the compound K₂LaI₅:Ce according to the invention, of the rare-earth iodide type, comprising 0.7 mol% of cerium (rare-earth basis, with y′=0.007) exhibits a decay time of the fast fluorescence component of 65 ns (against 230 ns for NaI:Tl). Table 1 shows the other scintillation results. In the case of the material of the example 3 according to the invention, the scintillation intensity of the fast component is noteworthy and above 30,000 photons/MeV. Moreover, the energy resolution under ¹³⁷Cs at 662 keV is significantly improved relative to that of NaI:Tl (comparative example 4) with values of around 5%. The rare-earth iodide material according to the invention offers significant advantages with regard to the scintillation properties relative to the versions based on other halogens, such as Cl (known in the literature) and Br, as is shown by the comparative examples 1 and 2. Such noteworthy results for the element iodine would not have been expected from the modest results of the version based on the element chlorine.

The material according to the invention in the example 4 (LuI₃:Ce) also possesses excellent characteristics, especially regarding stopping power (ρ.Z⁴) and decay time of the fast component.

TABLE 1

| | | | | | | | Percentage of |
|---|---|---|---|---|---|---|---|
| | | | | Emission | Energy | Fast | light emitted as |
| Example | Scintillator | y′ | Stopping | intensity | resolution | component | the fast |
| N° | material | (Ce³⁺) | power | (Photons/MeV) | at 662 keV | (ns) | component |
| 1 (comp) | K₂La_{1-y′}Cl₅:Ce_{y′} | 0.007 | 11 × 10⁶ | 21,000 | 5% | | |
| 2 (comp) | K₂La_{1-y′}Br₅:Ce_{y′} | 0.007 | 13 × 10⁶ | 26,000 | 7% | | 40% |
| 3 | K₂La_{1-y′}I₅:Ce_{y′} | 0.007 | 33 × 10⁶ | 52,000 | 5% | 65 | 90% |
| 4 | Lu_{1-y′}I₃:Ce_{y′} | 0.005 | 77 × 10⁶ | 33,000 | | 30 | |
| 5 (comp) | NaI:TI | — | 24 × 10⁶ | 40,000 | 6.5% | 230 | |

1. An inorganic scintillator material of the iodide type with a formula AₓLn_{(y-y′)}Ln′_{y′}I_{(x+3y)} wherein
A represents at least one element selected from the group consisting of Li, Na, K, Rb, and Cs,
Ln represents at least a first rare earth selected from the group consisting of La, Gd, Y, and Lu, said first rare earth being of valency 3+ in said formula,
Ln′ represents at least a second rare earth selected from the group consisting of Ce, Tb, Pr, said second rare earth being of valency 3+ in said formula,
x is an integer and represents 0, 1, 2 or 3,
y is an integer or non-integer value and greater than 0 but less than 3,
y′ is an integer or non-integer value greater than 0 and less than y.

2. The material as claimed in claim 1, wherein Ln′ is cerium (Ce).

3. The material as claimed in claim 1 , wherein y′ is in the range from 0.001 y to 0.1 y.

4. The material as claimed in claim 1, wherein y′ is in the range from 0.001 y to 0.01 y.

5. The material as claimed in claim 1, wherein y′ is in the range from 0.003 y to 0.01 y.

6. The material as claimed in claim 1, wherein y is equal to 1.

7. The material as claimed in claim 1, wherein Ln is lanthanum (La).

8. The material as claimed in claim 1, wherein A is potassium (K).

9. The material as claimed in claim 6, wherein the formula is K₂La_{(1-y′)}Ce_{y′}I₅.

10. The material as claimed in claim 6, wherein the formula is Lu_{(1-y′)}Ce_{y′}I₃.

11. The material as claimed in claim 1, wherein the material is a monocristalline and has a volume greater than 10 mm³.

12. The material as claimed in claim 1 having a volume greater than 1 cm³.

13. The material as claimed in claim 1, wherein the material is a crystallized powder or a polycrystal.

14. A method for the production of a single crystalline scintillator material as claimed in claim 11, wherein the material is obtained by the Bridgman growth method.

15. A scintillation detector comprising a scintillator material as claimed in claim 1, for applications in industry, the field of medicine and/or detection for oil drilling.

16. A positron emission tomography scanner comprising a detector as claimed in claim 15.

17. A gamma camera of the Anger type comprising a detector as claimed in claim 15.

18. The method of claim 14 wherein the material is obtained in a vacuum-sealed quartz bulbs.
